(19) United States
(12) Patent Application Publication
(10) Pub. No.: US 2010/0225944 A1
(43) Pub. Date: Sep. 9, 2010

(54) Online printing method and service

(76) Inventor: Itzhak Sapir, Irvine, CA (US)

Correspondence Address: ITZHAK SAPIR, 27 FOX HILL, IRVINE, CA, 92604, US

(21) Appl. No.: 12/660,656

(22) Filed: Mar. 2, 2010

Related U.S. Application Data
(60) Provisional application No. 61/208,999, filed on Mar. 3, 2009.

(51) Int. Cl. G06F 3/12

(52) U.S. Cl. 358/1.13

(57) ABSTRACT

The invention is of an online printing service that following the completion of registration and initial setup, installs a printer on the user's computer. The printer is a print manager and user interface program that receives the print command, manages the upload of files to the online service provider's servers and manages the order of prints. The main idea of this invention is the accessibility of this printer from every application and from every “Print” menu item while working on the computer. This includes selecting the “Print” menu item after right-clicking on a file name, selecting the “Print” menu item from the “File” menu in Windows Explorer and clicking the “Print” button or selecting the “Print” menu item within applications. The printer thus behaves like a local printer with the ease of use and accessibility of local printing but with the quality and convenience advantages of online printing.

### CROSS-REFERENCE TO RELATED APPLICATIONS

This application claims the benefit of U.S. provisional patent application no. 61/208,999, filed on Mar. 3, 2009, entitled “Improved Online Printing Service” pursuant to 35 USC 119, to which priority is claimed and which application is incorporated fully herein by reference.

### STATEMENT REGARDING FEDERALLY SPONSORED RESEARCH AND DEVELOPMENT

N/A

### FIELD OF THE INVENTION

The invention relates generally to the field of online printing services.

More specifically, the invention relates to a printer driver and user interface program installed on a user's computer for facilitating online printing.

### BACKGROUND OF THE INVENTION

Current online printing services require that you enter a website or start an application that connects to a website where you upload your documents (text, images, presentations etc.) and order the prints you need. This online printing method requires certain know-how and involvement that some users do not have or do not wish to perform every time they need to print a document. This is especially true for occasional photos you want to print while browsing the folders on your computer. The assumption made here is this method of ordering online prints causes the volume of business to be sub-optimal with many orders lost due to added ordering complexity comparing to the ease of local printing. At the same time, the use of a local printer has disadvantages such as the need for printer maintenance, purchase of materials, unavailable large print sizes and sometimes print quality and longevity. The online printing method and service described in this invention aim at combining the ease of operation of local printing with the advantages of online printing.

### SUMMARY OF THE INVENTION

Improved online printing method and service are hereby described. After completion of an initial one-time subscription and account setup, a printer (a print manager and user interface program) is installed on the user's computer. This printer is hereby referred to as “My Online Printing Service” (MOPS) printer. The MOPS printer looks and acts similar to any other local printer driver and user interface installed on the computer and is accessible from the same applications and access points as a local printer. The MOPS printer can also be made the default printer and be shared across a local network just like a local printer. Every time a print job is sent, the printer handles the document upload to the provider's server and the order of prints. These operations are transparent to the user and do not need any involvement on his side. All is needed for sending a print job is pressing the “Print” button within the application (and selecting the printer if it is not the default one). When a print job is sent, the printed documents with all their parameters are cached locally until the upload process is complete. This ensures that no print order is lost due to communication interruption. Controlling the printing settings (type of prints, size, paper etc.) is done at the time of sending the print job, the same way it is done when printing locally. In one mode of operation the documents are not printed at the time of upload but rather collected in a virtual storage bin associated with the user on the service provider's servers. In this mode of operation “Prepare for pickup” and “Mail prints” buttons are included in the MOPS printer's user interface to command actual printing and indicate whether documents should be mailed to a pre-determined address or wait for pickup.

The familiarity of the user with this method of printing and the immediate accessibility of the MOPS printer while browsing photos and documents, are aimed at significantly increasing the volume of online print orders.

Further benefits of the above invention include:
1. “Print” command is accessible at any time while using the computer and in the same way as when using a local printer. More specifically, right-clicking on a document or a photo and selecting the “Print” menu item will open the printer user interface in the same way as when printing locally.
2. The “Print” button in every application will start the “MOPS” printer if it is the default printer or will have the MOPS printer as a selectable printer from a list.

### BRIEF DESCRIPTION OF THE DRAWINGS

N/A

### DETAILED DESCRIPTION OF THE INVENTION

This invention describes an online printing method and service that combine the ease of use of local printing, mainly accessibility of the “Print” command from within applications and while browsing folders, with the advantages of online printing. The “My Online Printing Service” (MOPS) printer is a print manager and user interface program that is installed on the user's computer to allow a new method of online printing.

The first step needed is setting up an account with an online printing service provider. Details such as username, password, payment information etc. are entered as well as the default printing parameters such as default print size, type of paper, borderless prints etc. When the initial setup is complete, the MOPS printer is installed on the computer.

In its user interface function, the MOPS printer is just one more printer that appears in the computer's printers list alongside local and network printers. It is a name or an icon that is accessible from a list of selectable printers in an application's print menu or when clicking the “Print” menu item after right-clicking on a file. As such, the MOPS printer can be selected from within applications or when browsing folders and files. It can also be defined as the default printer or be shared across a local network just like a local printer. When the MOPS printer's user interface opens, printing parameters can be defined and defaults can be changed. Like with local printing, a document can be printed with a single click, in which case the print job will use the default printing parameters.

In its print manager function, the MOPS printer is responsible for taking the print job and handing it over to the online printing provider's server. When starting a print job, the MOPS printer cashes the documents with their print parameters locally and uploads them to the online server. It handles all communication issues and verifies that the job was received by the server with the right parameters. The purpose of local cashing is to prevent print jobs loss due to communication interruptions.

In one mode of operation the MOPS printer does not start the online printing immediately upon completion of the files' upload but rather collects the documents in the user's virtual storage bin on the server. When needed, a command from the MOPS printer's user interface is given to “Print and wait for pickup” or “Print and mail prints” as required by the user.

I claim:

1. A service for online printing that installs a printer driver on the user's computer where this printer driver is:
A print manager and user interface program
Accessible to the user by selecting the “Print” menu item after right-clicking on a file name while browsing folders on the computer

2. A service in claim 1 where the printer driver is selectable from a list of locally installed printers on the computer

3. A service in claim 1 where the printer driver can be defined as the default printer

4. A service in claim 1 where the printer driver can be shared across a local network with other computers

5. A service in claim 1 where the printer driver manages the upload of files to an online server

6. A service in claim 1 where the printer driver's user interface includes a “Print and prepare for pick up” command

7. A service in claim 1 where the printer driver's user interface includes a “Print and mail prints” command

8. A service for online printing that installs a printer driver on the user's computer where this printer driver is:
A print manager and user interface program
Accessible to the user by selecting the “Print” menu item in the “File” menu after selecting a file while browsing folders on the computer

9. A service in claim 8 where the printer driver is selectable from a list of locally installed printers on the computer

10. A service in claim 8 where the printer driver can be defined as the default printer

11. A service in claim 8 where the printer driver can be shared across a local network with other computers

12. A service in claim 8 where the printer driver manages the upload of files to an online server

13. A service in claim 8 where the printer driver's user interface includes a “Print and prepare for pick up” command

14. A service in claim 8 where the printer driver's user interface includes a “Print and mail prints” command

15. A service for online printing that installs a printer driver on the user's computer where this printer driver is:
A print manager and user interface program
Accessible to the user from the “Print” command (button or menu item) within applications (utility programs running on the computer such as Word, Photoshop, Photo managing programs, Excel, Power Point, Internet browsers, etc.)

16. A service in claim 15 where the printer driver is selectable from a list of locally installed printers on the computer

17. A service in claim 15 where the printer driver can be defined as the default printer

18. A service in claim 15 where the printer driver can be shared across a local network with other computers

19. A service in claim 15 where the printer driver manages the upload of files to an online server

20. A service in claim 15 where the printer driver's user interface includes a “Print and prepare for pick up” command

21. A service in claim 15 where the printer driver's user interface includes a “Print and mail prints” command
